(19) United States
(12) Patent Application Publication
(10) Pub. No.: US 2014/0266754 A1
(43) Pub. Date: Sep. 18, 2014

(54) DISC COUPLING BREAK MONITORING DEVICE

(71) Applicant: LOVEJOY, INC., Downers Grove, IL (US)

(72) Inventors: Mike Hennessy, Downers Grove, IL (US); Daniel R. Fagan, Plainfield, IL (US); James Krejci, Downers Grove, IL (US)

(73) Assignee: Lovejoy, Inc., Downers Grove, IL (US)

(21) Appl. No.: 13/826,491

(22) Filed: Mar. 14, 2013

(51) Int. Cl. G06K 7/10; G08B 23/00

(52) U.S. Cl. CPC G06K 7/10366; G08B 23/00
USPC 340/679

(57) ABSTRACT

A break monitoring device for use with a disc coupling having an outermost disc disposed on a disc pack. There is an RFID tag mounted on the outermost disc which transmits a signal to a receiver or monitor. The RFID may be an active or passive tag. When the RFID tag is broken due to the outermost disc failing, the signal sent to the receiver is different than the signal sent during normal operation. This triggers an alert that the outermost disc has failed and the machine can be shut down in an orderly manner.

### BACKGROUND AND SUMMARY OF INVENTION

This invention relates to disc couplings and more particularly to a device for monitoring when the disc pack begins to fail prior to a system failure.

Disc couplings are widely used in industrial applications to couple two shafts for the transmission of power from a driving source to a driven piece of machinery. Examples of disc couplings are found in disc couplings manufactured and sold by Lovejoy, Inc. located in Downers Grove Ill. Examples of disc couplings can be found in the Lovejoy, Inc. catalog under the section entitled “Disc Couplings” and are fully illustrated in the catalog. Generally the disc coupling uses two or more hubs and one or more disc packs mounted between the hubs. The disc packs are formed from multiple individual discs. In operation, the portion of the coupling that is prone to failure is the individual discs. Generally, the discs located on the outside of the pack fail before the internal discs fail. Once the disc on the outside of the pack fails, the life of the coupling becomes finite. The time to complete failure can be relatively short, and once the discs begin failing, the remaining discs need to absorb the additional load resulting in their rapid failure. If the failure of the outermost discs is not discovered early in the disc pack failure, the entire disc pack will eventually fail resulting in a system failure and shutdown.

In the past, in order to inspect the condition of the disc pack, the coupling guards had to be removed and the condition of the disc pack could be examined with a strobe light. This was done with the machine running, which presents a safety hazard as the machine should not be run with the coupling guards removed. Another disadvantage is that this type of inspection required a trained maintenance person to physically do the inspection. This method did not allow for continuous monitoring of the disc pack as the inspection only disclosed the condition of the disc at the moment in time that it is inspected. The disc may be ready to fail in the next few minutes or hours, and the maintenance person has no way of knowing the condition of the disc until the entire coupling failed.

Another method of disc coupling inspection is to shut down the machine and physically remove and inspect the coupling. This method is expensive as it requires a knowledgeable machine operator to disassemble the coupling, inspect the coupling and then reassemble the coupling. Furthermore this method results in expensive downtime while the machine is not operational.

Applicant's invention uses a passive or active radio frequency identification tag (“RFID”) and electrically conductive strip that establishes a circuit around the two outermost discs on either side of a disc pack. If the disc breaks or fractures, the circuit is broken and a transceiver receives a signal that triggers an alert. The machine can be shut down in an orderly process prior to sudden coupling failure and the coupling replaced.

### OBJECTS AND ADVANTAGES

It is an object of the invention to provide an early warning system to notify the operator of equipment using a disc pack coupling that the disc pack is prone to fail.

It is another object to provide a disc coupling break monitoring device that signals the breaking of the outermost disc in a disc pack so that the operator can shut down the equipment in an orderly manner.

It is another object to provide a disc pack monitoring device that uses an RFID tag that sends a signal to a receiver during normal operation and a different signal when the outermost disc breaks so that an alarm is activated.

A related advantage of the above objects is that the disc monitoring device operates continuously with the machinery operating and does not require the removal of the safety shields or shut down of the machine in order to examine the disc coupling.

### BRIEF DESCRIPTION OF THE DRAWINGS

FIG. 1 is a perspective exploded view of an industrial coupling on which the inventive device can be used.

FIG. 2 is a perspective view of an alternate embodiment of a disc coupling in which the disc pack is mounted directly to the hub.

FIG. 3 is a perspective view of the disc pack used in a disc coupling.

FIG. 4 is a front elevation view of the disc pack.

FIG. 5 is a cross sectional view of the disc pack taken along line 5-5 of FIG. 4.

FIG. 6 is a schematic view of the system illustrating the placement of the RFID tag on the perimeter of the disc and the remote display indicating no failure.

FIG. 6A is an enlarged view of the area “A” of FIG. 6 illustrating the RFID antenna is intact.

FIG. 7 is a schematic view of the system illustrating the RFID tag in the failed mode with the remote display indicating a failure.

FIG. 7A is an enlarged view showing the disc in failure more with the RFID antenna ruptured, with a failed alert being displayed.

FIG. 8 is an alternate embodiment of a disc pack with the outermost disc having one RFID tag and antenna around the entire disc.

### DESCRIPTION OF THE PREFERRED EMBODIMENT

FIG. 1 illustrates and describes the basic disc coupling 10. There are a series of discs 11 that comprise the disc pack 12. The disc pack 12 is mounted between a pair of hubs 14. Depending on the particular application, the configuration of the disc coupling varies, but the common feature is that the hubs 14 are separated by and coupled to each other by means of the discs 12. In the coupling illustrated in FIG. 1, which is a coupling sold by Lovejoy, Inc. of Downers Grove, Ill., the illustrated coupling is an Industrial DI Type Coupling. There are two guard rings or anti-flail flanges 16, each one mounted two one of the hubs 14. There is a disc pack 12 mounted between a spacer 18 and the anti-flail flange. In the alternate embodiment of FIG. 2, the disc pack 12 is mounted directly to and between two hubs 14 and no spacer or anti-flail flanges are used. In either instance, and throughout this application, there is a reference to an outermost disc 13, which is the exterior disc located on either side of the disc pack 12.

FIG. 3 illustrates the disc pack 12 which is attached to the hubs 14 by means of bolts or fasteners 20 and nuts 22. FIG. 4 is a front elevation view of the outermost disc 13 contained in the disc pack 12. FIG. 5 is a cross section view of the disc pack of FIG. 4 and illustrates that the disc pack 12 is comprised of a series of individual, thin steel discs 11 stacked adjacent to each other and fastened together by means of the fasteners 20 that pass through mounting holes 21 and secured by nuts 22. The thickness of the individual discs 11 is dictated by the design of the coupling.

FIG. 6 illustrates the inventive system and its operation. Radio Frequency Identification, (herein referred to as “RFID”) uses wireless non-contact radio-frequency (“RF”) electromagnetic fields to transfer data from a tag 24 attached to an object, for transmitting information about the object to which it is attached. Some tags require no battery or power source and are powered and read at short ranges (passive tags) and others require a power source and emit RF electromagnetic fields to be read by an RFID reader. The tag 24 contains electronically stored information which may be read from up to several meters away. Unlike a bar code reader, the tag 24 does not need to be within the line of sight of the RFID reader.

In the preferred embodiment applicant's invention uses a passive metal mounted tag 24. The tag 24 is comprised of an integrated circuit (“IC” or “chip”) 26 and a passive tag antenna 28. Although applicant suggests the use of a passive RFID chip, active chips that use a battery could also be used. FIG. 6 illustrates the placement of the tags 24 on the outermost discs 13. As seen in FIG. 6, multiple passive RFID tags 24 are placed around the perimeter of the outermost discs 13. One RFID tag 24 is placed between each of the mounting holes 21. The tag 24 is generally mounted by means of an appropriate adhesive so that it is securely attached to the disc 13 and will not come off when the disc pack 12 is spinning in normal operation.

During “Normal” operation, as seen in FIG. 6, the power source (not illustrated) drives the driven load through the coupling 10. The tag antenna 28 is intact as seen in FIG. 6A while the disc 13 and coupling 10 are functioning properly. A signal 30 from a transceiver 32 is sent to the tag 24. A return signal 34 from RFID tag antenna 28 to the transceiver 32 is received, read and interpreted by the transceiver 32 that in turn provides a digital signal to an external device. The external device can be a display, such as display 36, or an alarm or other similar signaling device. As seen in FIG. 6, the display 36 indicates all conditions are “Normal”.

As seen in FIG. 7, when the outermost disc 13 breaks or ruptures, as illustrated by a fracture line 38, the antenna 28 also breaks or ruptures. The return signal 34 sent by the RFID tag 24 to the transceiver 32 is different than the signal 34 sent when the antenna is unbroken and in the “normal” condition. A comparison of the signal in the normal condition to the signal sent when the antenna 28 is broken, indicates that the antenna 28 was interrupted. The transceiver compares the two signals 34 which indicates that a break in the antenna 28 occurred and sends a signal to the display 36 indicating a “Failed” mode. The display can also be tied into an audio alarm to alert the operator that the outermost disc 13 fractured and the machinery can be immediately shut down or have scheduled maintenance performed as the coupling 10 will still generally operate for a given time except in the most catastrophic situations. Of course the RFID tag 24 can rupture or break anywhere along the RFID tag 24 due to the location of where the outermost disc 13 fails. If the entire tag 24 fails, there will not be any signal transmitted to the transceiver 24, which will be detected at the transceiver 32 as a failure of the RFID tag 24.

In the alternate embodiment illustrated in FIG. 8, there is a single RFID tag 24 with the antenna 28 circumscribing the outermost disc 13. This singular RFID tag 24 replaces the multiple RFID tags illustrated in FIG. 6. If any portion of the antenna 28 ruptures, the signal 34 returned to the transceiver 32 will be different than the signal 34 returned when the RFID tag 24 is unbroken. Thus the transceiver 32 will generate an alarm signal.

Thus, the early warning system indicating that one of the outermost discs 13 has ruptured has achieved the purpose for which it is intended. No longer is visual inspection required to examine the condition of the disc 13 or disc pack 12. Rather the invention provides continuous monitoring of the outermost disc 13 without the necessity of a skilled maintenance person manually performing the inspection.

Thus there has been provided a disc coupling break monitoring device that fully satisfies the objects set forth above. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. a break monitoring device for use with a disc coupling having an outermost disc disposed on a disc pack comprising:
at least one RFID tag mounted on the outermost disc, the RFID tag transmitting a first signal;
monitoring means for receiving the first signal;
the RFID tag transmitting a second signal or no signal when the RFID tag is fractured due to the outermost disc breaking,
the monitoring means comparing the first signal to the second signal or first signal and no signal and transmitting an alert signal in response to detecting the change between the first and second signal or first signal and no signal.

2. The break monitoring device of claim 1 and further comprising at least several RFID tags mounted on the outermost disc, each of the RFID tags transmitting a signal to the monitoring means.

3. The break monitoring device of claim 2 and further comprising a second signal or no signal transmitted by any of the RFID tags when the RFID tag is fractured due to the outermost disc breaking.

4. The break monitoring device of claim 1 wherein the RFID tag has a transmitter means for transmitting the first signal during normal operating conditions and for transmitting the second signal or no signal when the outermost disc ruptures.

5. The break monitoring device of claim 4 wherein the monitoring device is also a radio frequency transmitter that transmits radio frequency signals to the RFID tag.

6. The break monitoring device of claim 5 wherein the RFID tag is a passive tag.

7. The break monitoring device of claim 1 wherein the RFID tag is an active tag with a power source on the tag.

8. A break monitoring device for use with a disc coupling comprising:
a disc pack having an outermost disc;
means for generating a radio frequency identification signal mounted on the outermost disc;
a first signal generated by the means for generating a radio frequency identification signal during normal operation of the disc coupling;
a second signal or no signal generated by the means for generating a radio frequency identification signal when the outermost disc has failed; and
signal receiving means for receiving the first and second signal or no signal and for comparing the first and second signal or first signal and no signal, the signal receiving means generating an alarm signal when the signal receiving means detects a predetermined difference in the first and second signals or first signal and no signal.

9. The break monitoring device of claim 8 wherein the means for generating a radio frequency identification signal is an RFID tag.

10. The break monitoring device of claim 9 and further comprising at least several RFID tags mounted on the outermost disc, each of the RFID tags transmitting a first signal to the monitoring means.

11. The break monitoring device of claim 10 wherein any of the RFID tags can generate a second signal or no signal when the RFID tag is ruptured.

12. The break monitoring device of claim 8 wherein the monitoring device is also a radio frequency transmitter that transmits radio frequency signals to the RFID tag.

13. The break monitoring device of claim 12 wherein the RFID tag is a passive tag.

14. The break monitoring device of claim 8 wherein the RFID tag is an active tag with a power source on the tag.

15. A method for detecting a break in the outermost disc of a disc pack in a disc pack coupling comprising the steps of:
mounting an RFID tag on the outermost disc in a disc pack;
generating a first signal from the RFID to a signal receiver during normal operation of the disc coupling;
generating a second signal or no signal from the RFID when the outermost disc has failed; and
comparing the first signal to the second signal or no signal and determining the difference in the first and second signals or first signal and no signal;
generating an alarm signal when the signal receiving means detects a predetermined difference in the first and second signals or first signal and no signal.

16. The method of claim 15 and the added step of mounting several RFID tags on the outermost disc in the disc pack.

17. The method of claim 16 and the added step of generating an alarm signal when the signal receiving means detects a predetermined difference in the first and second signals or the first signal and no signal in any of the RFID tags.
